(19) United States
(12) Patent Application Publication
(10) Pub. No.: US 2017/0230620 A1
(43) Pub. Date: Aug. 10, 2017

(54) CONTAINER USE STATE DETERMINING DEVICE

(71) Applicant: Panasonic Intellectual Property Management Co., Ltd., Osaka (JP)

(72) Inventor: KOU WATANABE, Osaka (JP)

(21) Appl. No.: 15/411,833

(22) Filed: Jan. 20, 2017

(30) Foreign Application Priority Data
Feb. 4, 2016 (JP) 2016-020012
Jan. 5, 2017 (JP) 2017-000318

(51) Int. Cl. H04N 7/18; G06F 3/14; B64D 11/00; G06K 9/00

(52) U.S. Cl. CPC H04N 7/181; G06K 9/00771; G06F 3/14; B64D 11/003

(57) ABSTRACT

A container use state determining device includes a signal input unit that receives image data generated by photographing at least one container; and a controller that determines a use state of the at least one container photographed from the image data and makes a display device display information indicating the use state based on a determination result.

### BACKGROUND

1. Technical Field

The present disclosure relates to a container use state determining device.

2. Description of the Related Art

A typical aircraft is equipped with containers that contain passengers' baggage over in-cabin seats. Such a container is provided with a door so that baggage inside the container will not jump out of it while the aircraft is moving.

A passenger who has entered the cabin visually searches for an empty container. On this occasion, a closed door of a container prevents the passenger from visually checking a use state of the container; they need to open the door. An empty container distant from the passenger is difficult for the passenger to identify the emptiness.

Patent literature 1 discloses a system that informs a state of a compartment of a cabinet using an LED. The system turns on the LED that informs a state of the compartment (e.g., space of the compartment, an open/closed state of the door) based on a detection result from a door sensor and a till detector. A user views the LED to monitor a state of the compartment (e.g., an open/closed state of the door).

### CITATION LIST

### Patent Literature

PTL 1 United States Patent Application 2001/0032118

### SUMMARY

The present disclosure provides a container use state determining device, provided in an aircraft for example, that allows a user or an administrator of the container to monitor a state.

An aspect of the disclosure provides a container use state determining device provided with an openable/closable door. The container use state determining device includes a signal input unit that receives image data generated by photographing at least one container; and a controller that determines a use state of the at least one container photographed from the image data and makes a display device display information indicating the use state based on the determination result.

According to the disclosure, the display device that displays information representing a use state of a container allows a user to easily monitor the state, which increases convenience for the user. Particularly, the device of the disclosure that determines a use state of a container based on an image of the container eliminates the need for attaching a sensor or a detector for detecting a state of the container, on the container, which allows a use state of the container to be determined with a simple configuration.

### BRIEF DESCRIPTION OF DRAWINGS

FIG. 1 illustrates the configuration of a use state determination device according to the first exemplary embodiment.

FIG. 2 illustrates the configuration of the control unit of the use state determination device.

FIG. 3A illustrates an image (a closed state) used for determining a use state of a container.

FIG. 3B illustrates an image (an open state) used for determining a use state of a container.

FIG. 4A illustrates divided regions for one determination-target region.

FIG. 4B illustrates a determination-target region allocated for each container.

FIG. 5 is a flowchart illustrating the process of determining a use state by the container use state determining device.

FIG. 6 is a flowchart illustrating the process of determining an open/closed state of the container by the container use state determination device.

FIG. 7A illustrates edges extracted from an image (a closed state) of the container.

FIG. 7B illustrates edges extracted from an image (an open state, no object contained) of the container.

FIG. 7C illustrates edges extracted from an image (an open state, some objects are contained) of the container.

FIG. 8 is a flowchart illustrating the process of determining whether or not an object is contained in a container by the container use state determination device.

FIG. 9 illustrates an example of displaying a use state of a container.

FIG. 10 illustrates an example of displaying a use state of a container.

FIG. 11A illustrates an example (in a text) of displaying a use state of a container.

FIG. 11B illustrates an example (in a text and graphics) of displaying a use state of a container.

FIG. 12A illustrates an example (configuration) of displaying a use state of a container.

FIG. 12B illustrates an example (no space) of displaying a use state of a container.

FIG. 12C illustrates an example (some space left) of displaying a use state of the container.

FIG. 12D illustrates an example (sufficient space left) of displaying a use state of a container.

FIG. 13 illustrates an example of a way of projecting information indicating a use state onto the door of a container.

FIG. 14 illustrates the configuration of a use state determination device equipped with multiple cameras according to the second exemplary embodiment.

FIG. 15 illustrates an example of displaying a use state of a container by the use state determining device according to the second embodiment.

FIG. 16 illustrates a network configuration for the use state determination device according to the second embodiment.

FIG. 17 illustrates the configuration of a use state determination device equipped with multiple cameras and multiple control units according to the third exemplary embodiment.

### DETAILED DESCRIPTION

Hereinafter, a detailed description is made of some embodiments with reference to the related drawings as appropriate. However, a detailed description more than necessary may be omitted, such as a description of a well-known item and a duplicate description for a substantially identical component, to avoid an unnecessarily redundant description and to allow those skilled in the art to easily understand the following description.

Note that the inventor provides accompanying drawings and the following description for those skilled in the art to well understand the disclosure and does not intend to limit the subjects described in the claims by the drawings and the description.

### First Exemplary Embodiment

### 1-1. Configuration

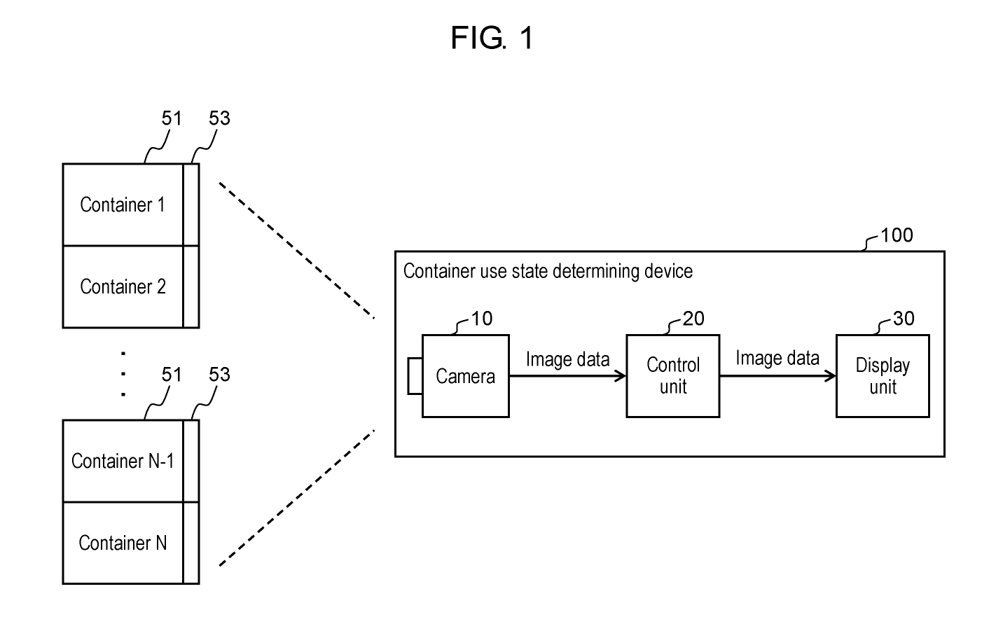

FIG. 1 illustrates the configuration of a container use state determining device according to the first embodiment. Container use state determining device 100 of the disclosure determines a use state of container 51 placed inside an aircraft to display information indicating a use state based on the determination result. Container use state determining device 100 includes camera 10, control unit 20, and display unit 30.

Camera 10 includes an image sensor such as a CCD (charge-coupled device) image sensor and a CMOS (complementary metal oxide semiconductor) image sensor, and photographs an image of a subject to generate image data (moving or still). Camera 10 photographs an image when door 53 of container 51 is in an open state or a closed state. Camera 10 is placed at a given position inside the cabin of the aircraft, for example on the ceiling or the side wall of the cabin. One or more cameras 10 are placed inside the cabin of the aircraft.

Control unit 20 receives an input of image data of container 51 generated by camera 10 and analyzes the image data to determine a use state of container 51. Control unit 20 generates image data for displaying information indicating a use state based on the determination result and outputs the image data to display unit 30.

Display unit 30 displays information such as images and characters. Display unit 30 receives image data from control unit 20 and displays an image based on the image data received. Display unit 30 may be placed at each seat inside the aircraft. Alternatively, display unit 30 may be a large display placed at a position (excluding each seat) inside the aircraft cabin so as to allow more than one passenger to view the display. Besides, display unit 30 may be a device for cabin attendants placed where passengers usually cannot view it.

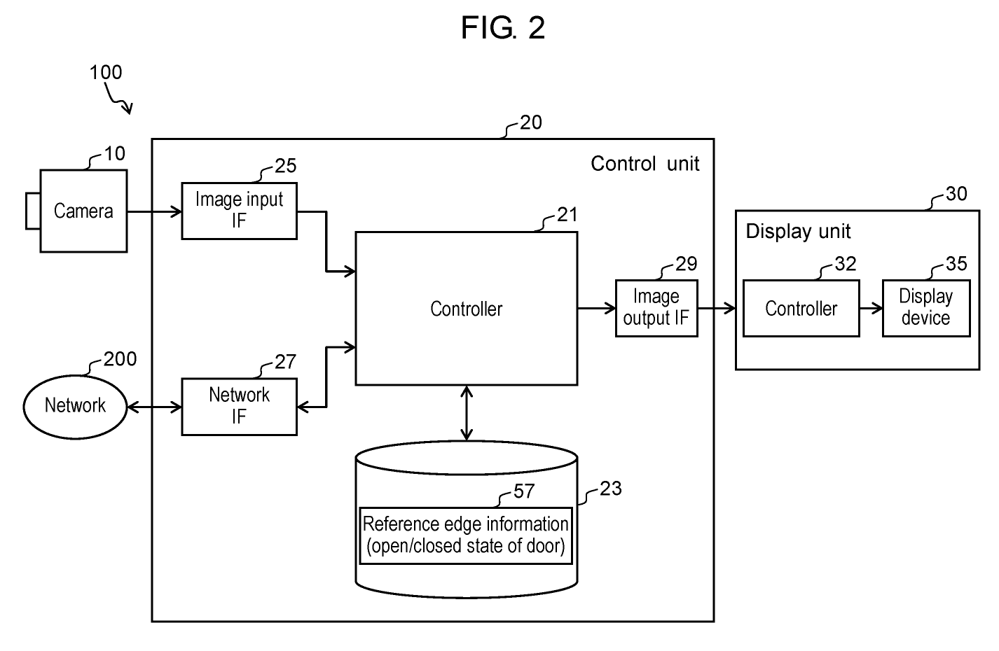

FIG. 2 illustrates the internal configuration of control unit 20 and display unit 30 of container use state determining device 100. Control unit 20 includes controller 21, recording medium 23, image input interface (IF) 25, network interface (IF) 27, and image output interface (IF) 29.

Controller 21 of control unit 20 controls operation of control unit 20 and is a processor that executes given programs to perform given functions. Controller 21 may be a circuit designed to perform given functions. Concretely, controller 21 represents a CPU (central processing unit), an MPU (micro processing unit), a DSP (digital single processor), an FPGA (field programmable gate array), or an ASIC (application specific integrated circuit) for example.

Recording medium 23 stores programs and data and represents an HDD (hard disk drive) or an SSD (solid state drive).

Image input IF 25 is an input terminal or a circuit, or a combination of them, for receiving image data from camera 10. Network interface 27 is used for connecting with a network such as a LAN (local area network). Network interface 27 is connected with a network wiredly or wirelessly. Image output IF 29 is an output terminal or a circuit, or a combination of them, for outputting information to be displayed on display unit 30 to display unit 30 as image data.

Display unit 30 includes controller 32 and display device 35. Controller 32 controls operation of display unit 30 and is a processor that executes given programs to perform given functions. Controller 32 may be a circuit designed to perform given functions. Concretely, controller 32 represents a CPU, MPU, DSP, FPGA, or ASIC for example. Display device 35 represents a liquid crystal display, organic EL (electroluminescence) display, projector, or LED, or a combination of them. Controller 32 controls display device 35 based on image data received from control unit 20.

Control unit 20 configured as described above may be incorporated into camera 10 or display unit 30.

### 1-2. Operation

Hereinafter, a description is made of operation of container use state determining device 100 configured as described above. Container use state determining device 100 determines a use state of container 51 and makes display unit 30 display information indicating the use state based on the determination result.

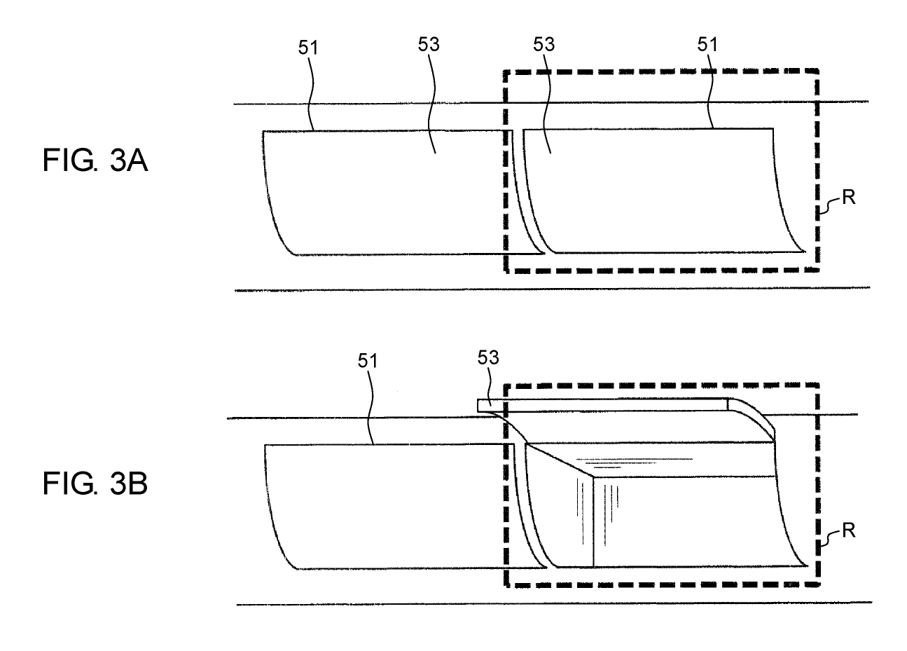

For example, camera 10 takes an image of container 51 as shown in FIG. 3A or 3B. FIG. 3A illustrates an image of two containers 51 taken by camera 10 with their doors 53 closed. FIG. 3B illustrates an image of two containers 51 taken by camera 10 with one door 53 open. Container use state determining device 100 analyzes such an image of a container taken by camera 10 to determine an open/closed state of door 53 and a use state of container 51. For this purpose, determination-target region R is allocated for a container in an image as shown in FIGS. 3A and 3B (details are described later).

Control unit 20 receives an input of image data representing an image of container 51 from camera 10 and analyzes the image data to determine (perceive) a use state (i.e., an open/closed state of container 51, a state of baggage disposed in container 51) of container 51. Control unit 20 generates information indicating a use state of container 51 as image data based on the determination result and makes display unit 30 display the image data.

Container use state determining device 100 preliminarily stores two pieces of reference edge information 57 (one is extracted from an image in a closed state, and the other is from an image in an open state, of door 53 of container 51) in recording medium 23 in order to determine a use state of a container.

Concretely, camera 10 takes an image (refer to determination-target region R in FIG. 3A) of container 51 with its door 53 closed. Controller 21 of control unit 20 obtains image data representing an image of container 51 with door 53 closed, from camera 10. Controller 21 analyzes the image data obtained; discriminates a color (red (R), green (G), or blue (B)) for each pixel; and extracts discontinuous parts of the image and points of variation in density to extract edges. Controller 21 stores information related to edges extracted as reference edge information 57 indicating a closed state of container 51 in recording medium 23.

Camera 10 takes an image (refer to determination-target region R in FIG. 3B) of container 51 with its door 53 open and at the same time with no baggage contained. Controller 21 of control unit 20 obtains image data indicating an image of container 51 with its door 53 open from camera 10. Controller 21 analyzes the image data obtained to extract edges. Controller 21 stores information related to the edges extracted as reference edge information 57 indicating an open state of container 51 in recording medium 23.

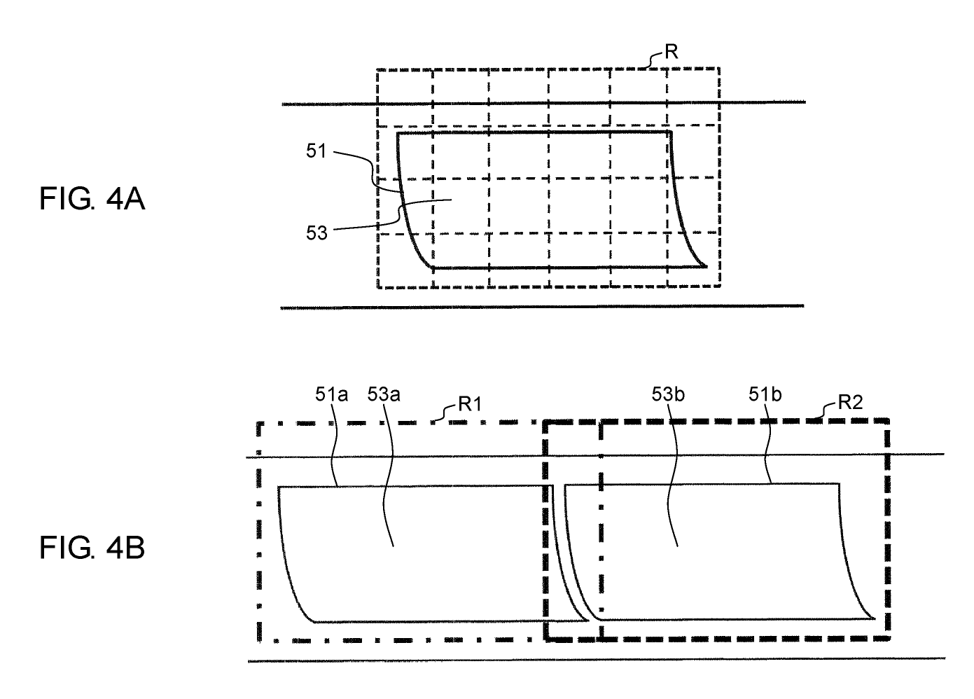

In this way, recording medium 23 preliminarily stores reference edge information 57 that indicating an open state of container 51 and reference edge information 57 that indicating a closed state of container 51. In this case, the following way may be used. That is, determination-target region R is divided into multiple small regions as shown in FIG. 4A. Reference edge information 57 indicating an open state of container 51 is compared with that of a closed state for each region divided. Discrimination is made between similar parts and dissimilar parts. Then, reference edge information 57 indicating an open state and a closed state of container 51 for dissimilar parts is stored in recording medium 23. This way allows efficient determination of an open/closed state of door 53 of container 51.

### 1-2-1. Determination of a Use State of a Container

Hereinafter, a description is made of the process of determining a use state of container 51 by container use state determining device 100.

Camera 10 takes an image of container 51; generates image data that is information indicating an open/closed state of door 53 of container 51 and/or a use state of container 51; and transmits the data to control unit 20. Here, one camera 10 takes an image of multiple (two in this embodiment) containers 51. To determine a use state of each container, determination-target region R is allocated for each container in the image generated by camera 10. For example, determination-target regions R1 and R2 are respectively allocated for two containers 51a and 51b as shown in FIG. 4B. This allows determination of a use state for each container 51. In the examples shown in FIGS. 3A, 3B, and 4B in this embodiment, one camera 10 takes an image of two containers, but not limited to it. One camera 10 may photograph any number of containers.

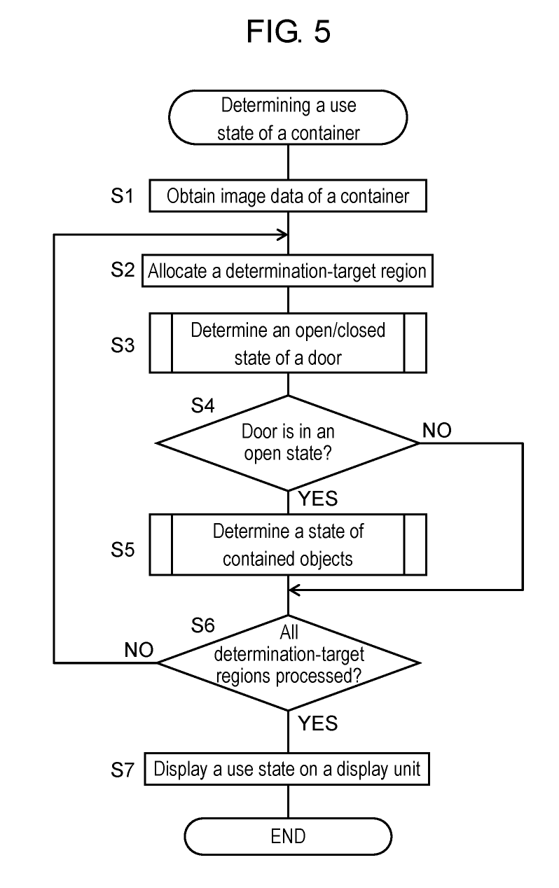

FIG. 5 is a flowchart illustrating the process of determining a use state of container 51 executed by controller 21 of control unit 20.

Controller 21 of control unit 20 obtains image data of an image (moving or still) of container 51 from camera 10 (S1). Controller 21 allocates one target region to be processed from multiple determination-target regions (S2).

Controller 21 performs the process of determining an open/closed state of door 53 of container 51 based on an image in determination-target region R allocated (S3). This process determines whether door 53 of container 51 in determination-target region R is in an open state or a closed state. The determination result is recorded in recording medium 23. Further details about this determination process are described later.

If the determination result represents door 53 in an open state (yes in S4), controller 21 further performs the process of determining a state of objects contained in container 51 (S5). This process determines the number of baggage pieces contained in container 51 and an occupancy state of baggage in the storage space for example. The determination result is recorded in recording medium 23. Details about this determination process are described later.

After the process of determining a state of contained objects (S5) ends or when it is determined that door 53 is in a closed state (no in S4), controller 21 determines whether or not all the determination processes (S3 to S5) have been performed for all determination-target regions R (S6). If all of them have been performed (yes in S6), controller 21 makes display unit 30 display information indicating a use state of each container 51 based on the determination result recorded in recording medium 23 (S7). Concretely, controller 21 generates information indicating a use state to be displayed on display unit 30 based on the determination result, and outputs the information to display unit 30 for displaying. If there is determination-target region R that has not undergone the determination process (S3 to S5) (no in S6), the process returns to step S2, and controller 21 allocates next determination-target region R to perform the determination process (S3 to S5).

As described above, container use state determining device 100 determines a use state of container 51 based on an image of container 51 obtained from camera 10 and displays information indicating the use state on display unit 30. This allows passengers and cabin attendants to visually learn and to easily perceive a use state of container 51.

Next, detailed description is made of the process of determining an open/closed state of a container door (S3) and the process of determining a state of contained objects (S5).

### 1-2-1-1. Process of Determining an Open/Closed State of a Container Door

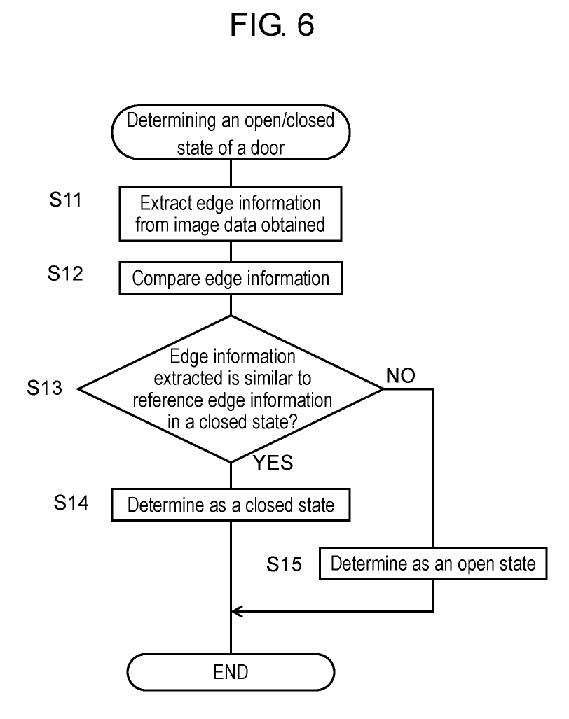

FIG. 6 is a flowchart illustrating the process (S3 in FIG. 5) of determining an open/closed state of door 53 of container 51 executed by controller 21 of control unit 20. A description is made of the process of determining an open/closed state of door 53 of container 51 in reference to the flowchart of FIG. 6.

Controller 21 extracts edge information from image data obtained from camera 10 (S11). Controller 21 compares the edge information extracted with the reference edge information 57 (for a closed state and an open state) stored in recording medium 23 (S12).

If the edge information extracted is more similar to the reference edge information 57 in a closed state than that in an open state (yes in S13), controller 21 determines that door 53 of container 51 is in a closed state (S14). Meanwhile, if the edge information extracted is more similar to the reference edge information 57 in an open state than that in a closed state (no in S13), controller 21 determines that door 53 of container 51 is in an open state (S15). Controller 21 stores the determination result in recording medium 23.

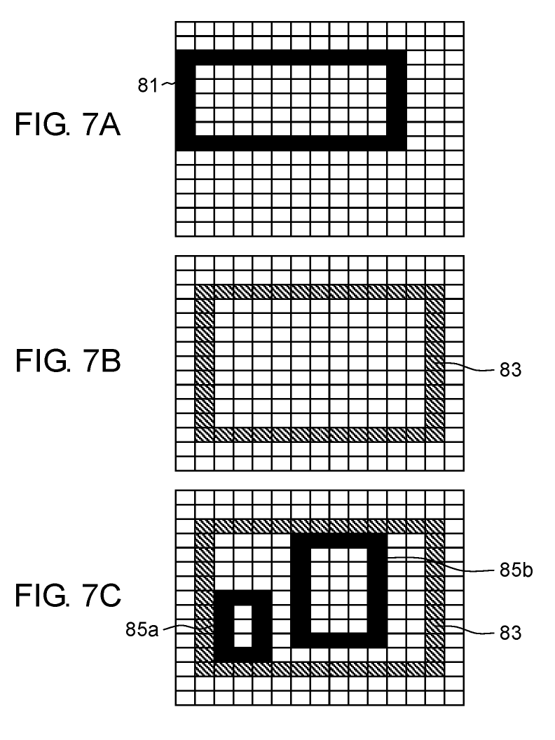

FIGS. 7A through 7C illustrate examples of edges extracted when door 53 of container 51 is in an open state or a closed state. FIG. 7A shows edge 81 (the reference edge information 57 in a closed state) when door 53 of container 51 is in a closed state. FIG. 7B shows edge 83 (the reference edge information 57 in an open state) when door 53 of container 51 is in an open state and container 51 contains no object. FIG. 7C shows edges when door 53 of container 51 is in an open state and container 51 contains one or more objects, and indicates that edges 85a and 85b (in addition to edge 83) have been extracted. For example, if edge information extracted is as shown in FIG. 7C, edge 83 of the edge information shown in FIG. 7C is common to edge 83 shown in FIG. 7B, and thus it is determined that the edge information shown in FIG. 7C is similar to the reference edge information 57 in an open state.

### 1-2-1-2. Determining a State of Contained Objects

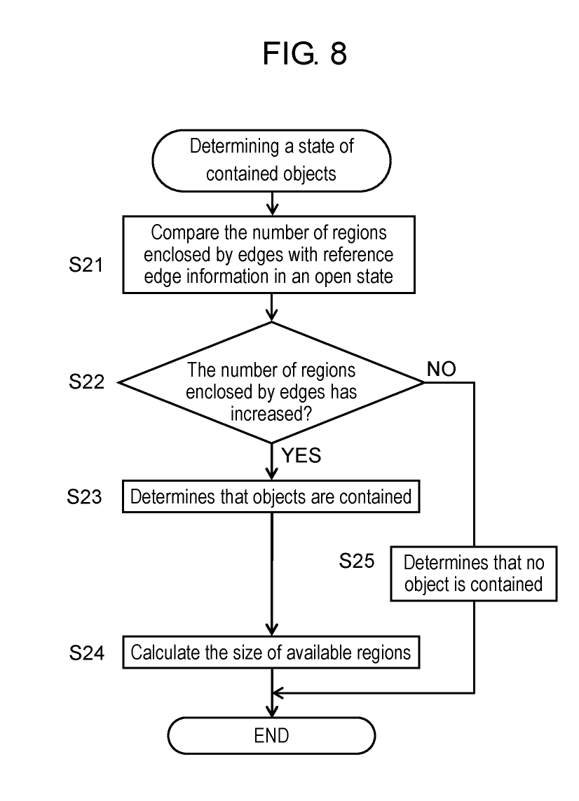

FIG. 8 is a flowchart illustrating the process (S5 in FIG. 5) of determining a state of objects contained in container 51 executed by controller 21 of control unit 20. A description is made of the process of determining a state of objects contained in container 51 in reference to the flowchart of FIG. 8.

Controller 21 compares edge information extracted from image data obtained from camera 10 with the reference edge information 57 in an open state (S21). Controller 21 determines whether or not the number of regions enclosed by the edges indicated by the edge information extracted is larger than that enclosed by the edges indicated by the reference edge information 57 in an open state (S22). If larger (yes in S22), controller 21 determines that container 51 contains objects (S23). In this case, controller 21 calculates the size of a region available for objects based on the region enclosed by edges (S24).

For example, if the edge information extracted is as shown in FIG. 7C, the number of regions enclosed by edges is three. Meanwhile, according to the reference edge information 57 in an open state of door 53 of the container, the number of regions enclosed by edges is one as shown in FIG. 7B. In this case, therefore, the number of regions enclosed by edges has increased from one to three, and thus determination is made that the container contains objects.

Controller 21 is capable of calculating the size of a container and the size of contained objects based on the size of a region enclosed by edges through estimation, which provides the size of a region (empty space in container 51) available for objects.

Meanwhile, if the number of regions enclosed by the edges indicated by the edge information extracted is equal to or smaller than that enclosed by the edges indicated by the reference edge information 57 in an open state (no in S22), controller 21 determines that container 51 contains no object (S25). The calculation result of the size of the region available for objects and the determination result of whether or not a container contains objects are stored in recording medium 23 for later reference.

### 1-2-2. Way of Displaying a Use State

Hereinafter, a description is made of a way display unit 30 displays information indicating a use state of container 51.

### (1) Example 1 of a Way of Displaying

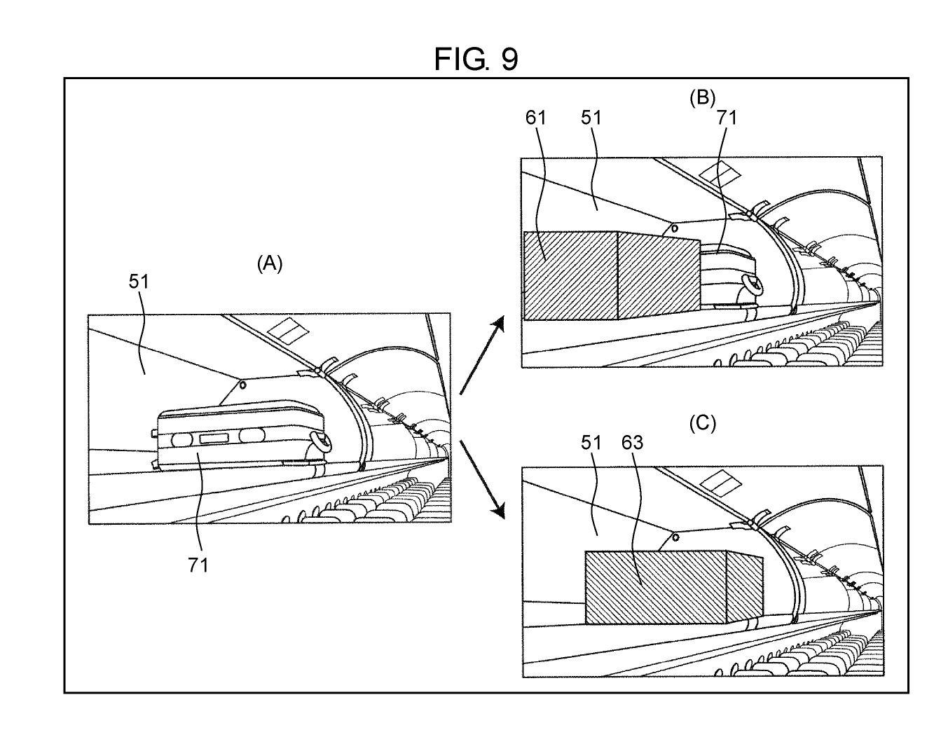

FIG. 9 shows an example of a way display unit 30 displays information indicating a use state. FIG. 9(A) shows an example of an image (still or moving) of container 51 taken by camera 10. In FIG. 9(A), container 51 contains one bag 71.

The example of FIG. 9(B) shows graphic display 61 generated by computer graphics synthesized near bag 71 in the image of FIG. 9(A). Graphic display 61 shows an empty space next to bag 71 in container 51, where graphic display 61 may blink in a single color for example. The example of FIG. 9(C) shows graphic display 63 generated by computer graphics so as to mask bag 71 in the image of FIG. 9(A). Graphic display 63 shows the position and size (occupied space) of an object (bag 71) in container 51.

The display as shown in FIGS. 9(B) and 9(C) allows aircraft passengers and cabin attendants to intuitively perceive the availability and size of an empty space. Graphic displays 61 and 63 shown in FIGS. 9(B) and 9(C) are generated by controller 21 of control unit 20 and are displayed on display unit 30.

### (2) Example 2 of a Way of Displaying

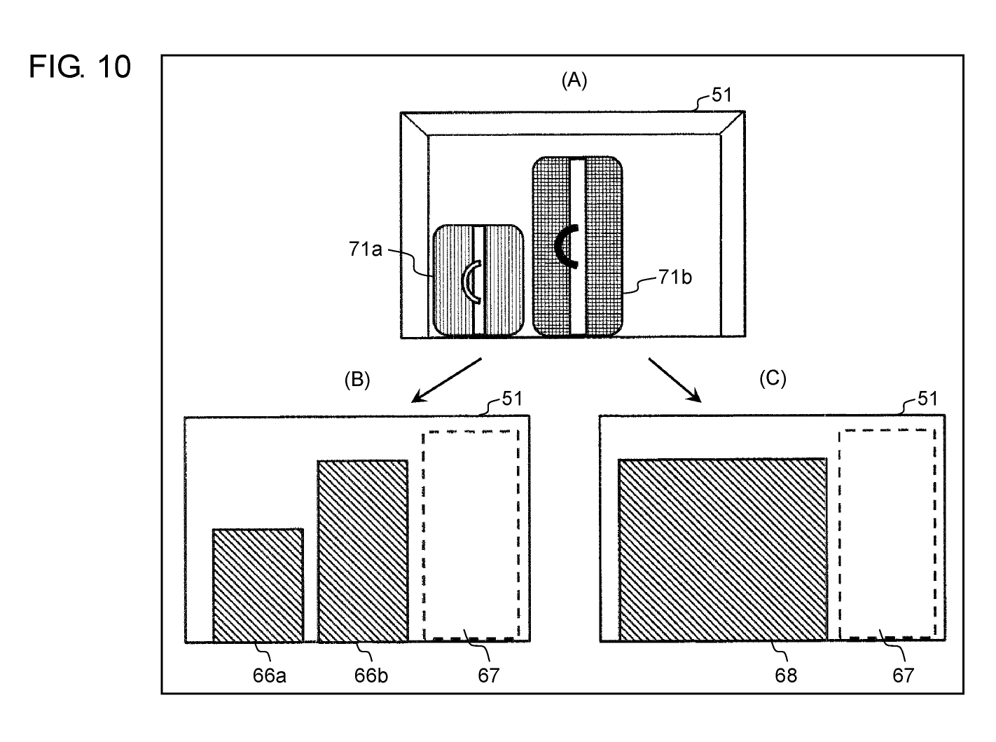

FIG. 10 shows another example of a way display unit 30 displays information indicating a use state. FIG. 10(A) shows an example of an image (still or moving) of container 51 taken by camera 10. The image of FIG. 10(A) shows two (large and small) bags 71a and 71b contained in container 51. In the circumstances as shown in FIG. 10(A), controller 21 of control unit 20 may generate graphic images (computer graphics) as shown in FIG. 10(B) or 10(C) to output image data representing the graphic images to display unit 30 for displaying them on display unit 30.

In the example of FIG. 10(B), the occupied spaces respectively corresponding to bags 71a and 71b are shown in graphic displays 66a and 66b indicated with hatched areas while an empty space is shown in graphic display 67 indicated with a broken-line frame. In the example of FIG. 10(C), the entire space occupied by bags 71a and 71b is shown in graphic display 68 indicated with one hatched area while an empty space is shown in graphic display 67 indicated with a broken-line frame. Even such a way allows aircraft passengers and cabin attendants to intuitively perceive the availability and size of an empty space.

### (3) Example 3 of a Way of Displaying

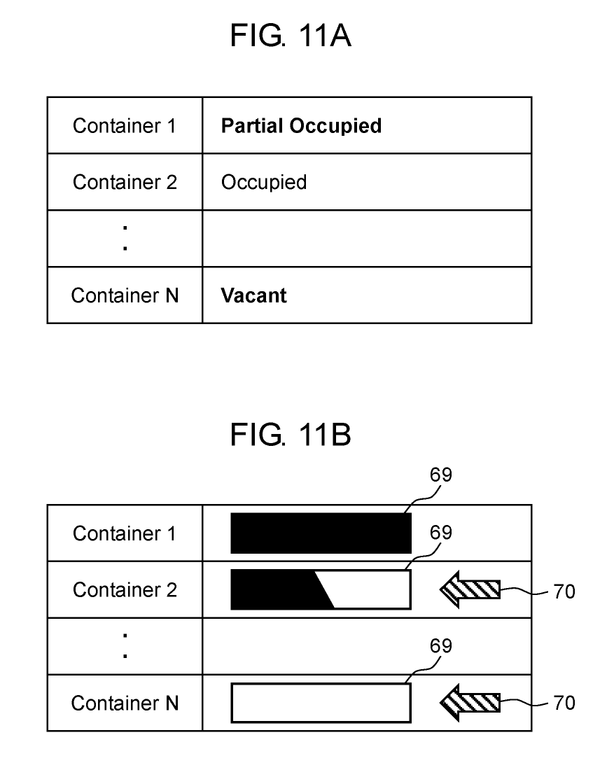

Controller 21 of control unit 20 may show information indicating a use state in a text. FIG. 11A shows an example of displaying a use state of container 51 using a text. In the example of FIG. 11A, a text indicating a use state may be displayed with its font type, color, size, and background color changed, or blinked for easier discrimination between use states.

FIG. 11B shows an example where a use state of container 51 is displayed in a graphic image and a text combined. For example, a bar indicating a use state may be displayed only in graphic display 69. In graphic display 69 of the bar, the black part indicates the amount of a space occupied by baggage, and the white part indicates the amount of an available empty space. In addition to graphic display 69 of the bar, graphic display 70 (an example of a mark) in an arrow may be added to a container with an empty space in order to catch attention from aircraft passengers and cabin attendants.

### (4) Example 4 of a Way of Displaying

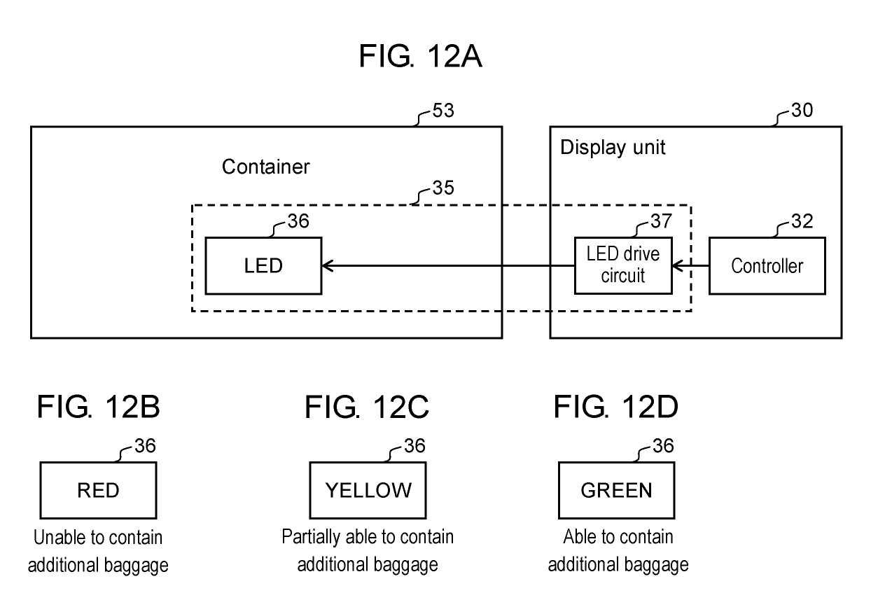

An LED may be used as display device 35. An LED is attached on the surface of door 53 of a container or near door 53 for example. In this case, as shown in FIG. 12A, display device 35 of display unit 30 includes LED 36 and LED drive circuit 37 for driving LED 36. In this case, controller 32 receives information indicating a use state of each container 51 from control unit 20. Then, controller 32 transmits a control signal for controlling light emission of LED 36 based on the information to LED drive circuit 37. LED 36 is controlled to emit light in different colors in response to a use state of container 51.

For example, if container 51 is full of baggage and is unable to contain additional baggage, LED 36 is made to emit red light as shown in FIG. 12B. If container 51 is partially empty and is able to contain additional baggage, LED 36 is made to emit yellow light as shown in FIG. 12C. If container 51 is fully empty and is able to contain baggage, LED 36 is made to emit green light as shown in FIG. 12D. In the examples of FIGS. 12B through 12D, LED 36 is controlled to change display according to a use state of three levels. LED 36 may be controlled to change display according to a use state of more levels.

### (5) Example 5 of a Way of Displaying

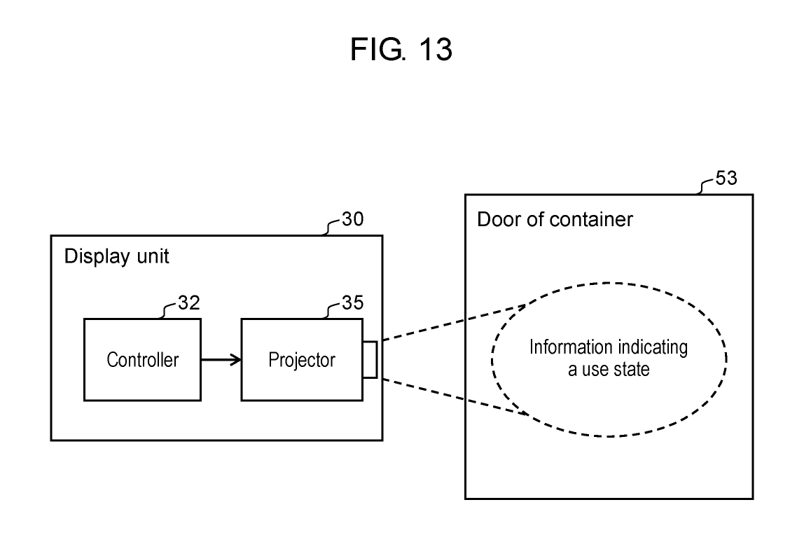

Information indicating a use state of container 51 may be projected directly onto door 53 of container 51. In this case, display unit 30 has a projector as display device 35 as shown in FIG. 13. Controller 32 drives the projector based on image data received from control unit 20 and makes images based on the image data be projected onto the surface of door 53 of the container. Projecting information onto door 53 of the container allows aircraft passengers and cabin attendants to learn a use state of container 51 more easily. Here, information projected by the projector may be that shown in FIG. 9(B), 9(C), 10(B), 10(C), 11A, or 11B. The projector may project colors (red, yellow, and green) that LED 36 described in example 4 of a way of displaying displays according to a use state.

### 1-3. Advantages

As described above, container use state determining device 100 of this embodiment is a device that determines a use state of container 51 provided with openable/closable door 53. Container use state determining device 100 includes image input IF 25 that receives an input of image data of at least one container 51 photographed and controller 21 that determines a use state of container 51 photographed from an image represented by the image data that has been input and makes display unit 30 display information indicating the use state based on the determination result.

With this configuration, information indicating a use state of container 51 is displayed on display unit 30. This allows aircraft passengers and cabin attendants to visually learn and to easily perceive a use state of container 51.

A use state of container 51 is determined based on an image of container 51 taken by camera 10. This eliminates the need for attaching a sensor or a detector for detecting a state of the container, on the container, which allows a use state of the container to be determined with a simple configuration.

### Second Exemplary Embodiment

In the first embodiment, a use state of a container based on information from one camera 10 is displayed on display unit 30. In this embodiment, on the other hand, a description is made of a configuration for displaying a use state of a container based on information from more than one camera.

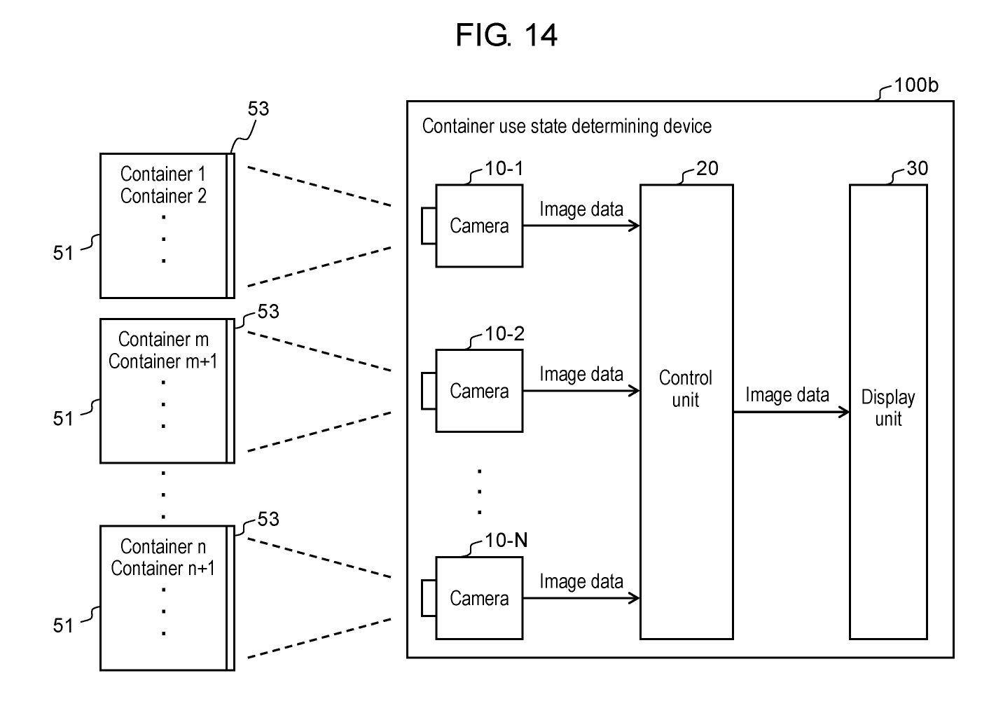

FIG. 14 illustrates the configuration of container use state determining device 100b according to the second exemplary embodiment. Container use state determining device 100b includes multiple (N, N is two or more) cameras 10. Cameras 10-1, 10-2, . . . , and 10-N have respective view angles assigned so as to photograph a container within a given range. Image data from the cameras is input to control unit 20.

Control unit 20 analyzes the image data input from the cameras to determine a use state of the container group photographed by the cameras. Control unit 20 generates image information indicating a use state of a container based on image data input from the cameras, for each camera. Then, control unit 20 generates image data and transmits it to display unit 30 so that the image information generated for each camera is displayed on display unit 30 in a successively changing manner.

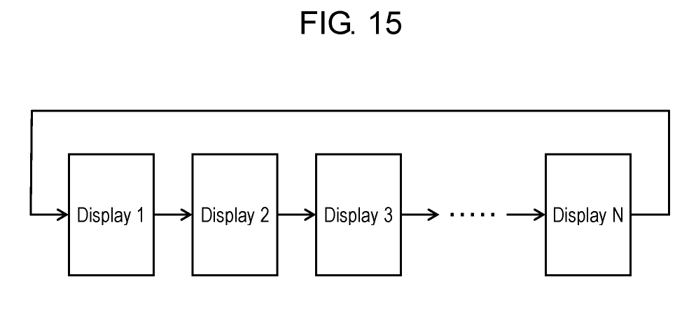

For example, the display on display unit 30 indicating a use state of container 51 is changed as shown in FIG. 15 (display 1, display 2, display 3, . . . , and display N successively). Here, display 1 refers to display indicating a use state of the container group (containers 1, 2, . . . ) photographed by first camera 10-1. Display 2 refers to display indicating a use state of the container group (containers m, m+1, . . . ) photographed by second camera 10-2. Display N refers to display indicating a use state of the container group (containers n, n+1, . . . ) photographed by Nth camera 10-N. After display of each group is displayed for a given time, the display is changed to the next group. Then, after display N for the last group is displayed for a given time, the display returns to display 1 for the first group.

Thus cyclicly changing the display on display unit 30 enables the result of determining a use state based on images from cameras 10-1, 10-2, . . . , and 10-N to be displayed on one display unit 30. This allows aircraft passengers and cabin attendants to view one display unit 30 to perceive the availability of containers 51 in a wide range.

In this case, when display unit 30 displays information while changing the display for each container group as shown in FIG. 15, a use state may be displayed only for a container with a given amount or more of space. This allows aircraft passengers and cabin attendants to identify an available container more rapidly.

When display unit 30 displays information while changing the display for each container group, changing may be made in the order of the distance from display unit 30 to a container in each group. For example, the display is changed in the order of display 1, display 2, . . . , and display N in the following condition. That is, the group of containers 1, 2, . . . photographed by first camera 10-1 is closest to display unit 30; the group of containers m, m+1, . . . photographed by second camera 10-2 is next closest to display unit 30; and the group of containers n, n+1, . . . photographed by Nth camera 10-N is farthest from display unit 30.

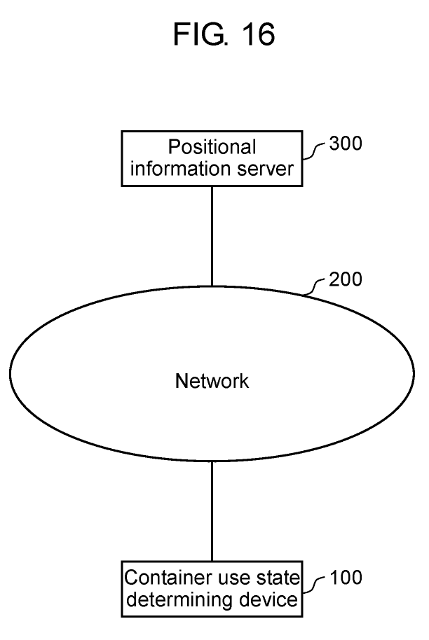

In order to change the display successively according to the distance between the display unit and a container, control unit 20 needs to know positional relationship between display unit 30 and a container group photographed by each camera. For this reason, as shown in FIG. 16, container use state determining device 100 is connected to in-flight network 200 and is connected to positional information server 300 that administrates the position of display unit 30 and the positions of containers 51 photographed by each camera, via network 200.

Container use state determining device 100 (control unit 20) obtains positional information of display unit 30 and of containers 51 photographed by each camera from positional information server 300 via network 200. Based on the positional information, control unit 20 can know the distance between display unit 30 and container 51 to change the display of a use state on display unit 30 successively according to the distance between display unit 30 and container 51.

Here, control unit 20 may make one display unit 30 display images photographed by cameras 10-1, 10-2, . . . , and 10-N and/or information indicating a use state obtained from the images.

### Third Exemplary Embodiment

A description is made of still another configuration of a use state determination device of the disclosure. In this embodiment as well, a use state of a container based on information from more than one camera is displayed on display unit 30 in the same way as the second embodiment. The use state determination device of this embodiment is different from container use state determining device 100b of the second embodiment in that a control unit is provided for each camera.

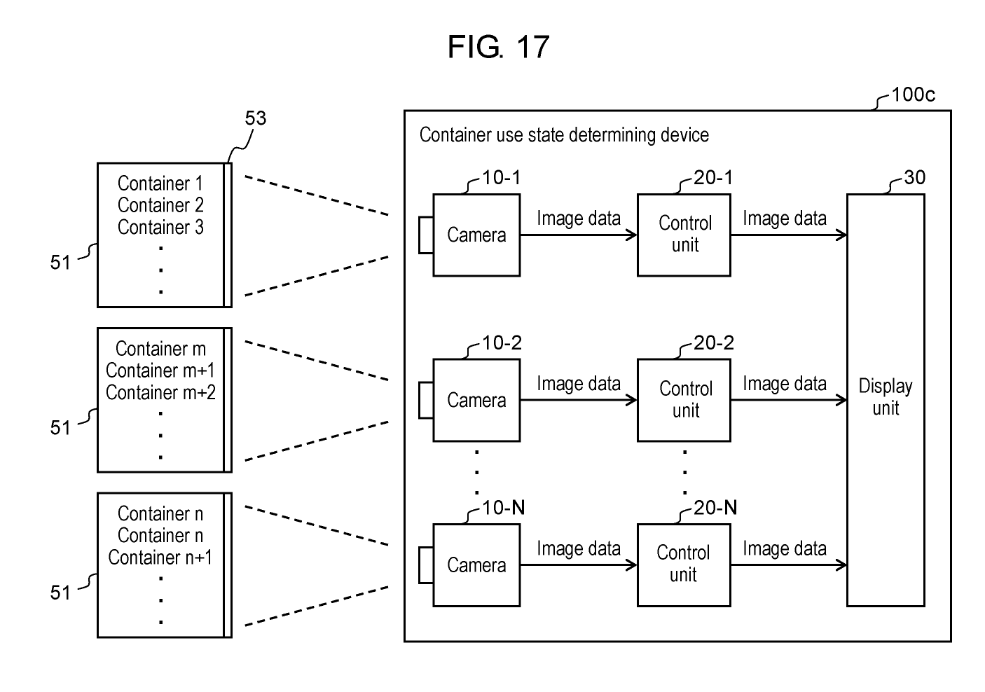

FIG. 17 illustrates the configuration of a use state determination device according to the third embodiment. Container use state determining device 100c includes multiple cameras 10-1, 10-2, . . . , multiple control units 20-1, 20-2, . . . , and display unit 30.

Control units 20-1, 20-2, . . . , and 20-N respectively receive an input of image data from cameras 10-1, 10-2, . . . , and 10-N. Control units 20-1, 20-2, . . . , and 20-N respectively analyze images input from cameras 10-1, 10-2, . . . , and 10-N to determine a use state of containers photographed by cameras 10-1, 10-2, . . . , and 10-N. Control units 20-1, 20-2, . . . , and 20-N respectively generate image data indicating a use state of containers based on image data from cameras 10-1, 10-2, . . . , and 10-N. Display unit 30 receives an input of image data indicating a use state of containers from respective control units 20-1, 20-2, . . . , and 20-N.

As shown in FIG. 2, display unit 30 includes controller 32 and display device 35. Controller 32 of display unit 30 displays image information based on image data received from control units 20-1, 20-2, . . . , and 20-N in a successively changing manner as shown in FIG. 15.

Such a configuration as well enables the result of determining a use state based on images from cameras 10-1, 10-2, . . . , and 10-N to be displayed on one display unit 30. This allows aircraft passengers and cabin attendants to view one display unit 30 to perceive the availability of containers 51 in a wide range.

### Other Exemplary Embodiments

Hereinbefore, the first through third embodiments are described to exemplify the technology disclosed in this patent application. The technology of the disclosure, however, is not limited to these embodiments, but is applicable to other embodiments appropriately devised through modification, substitution, addition, and omission for example. Further, some components described in the embodiments can be combined to devise a new embodiment. Hence, other exemplary embodiments are exemplified hereinafter.

In the above-described embodiments, containers placed inside an aircraft are targeted for determining a use state, but not limited to them. The design concept of the disclosure is applicable to any containers as long as they can contain baggage. For example, the concept is applicable to containers placed in a mobile object such as a railway vehicle and an automobile, and those placed outdoor and indoor.

Information indicating a use state displayed on display unit 30 shown in the above-described embodiment is a mere example and is not limited to it.

In the above-described embodiment, control unit 20 generates information indicating a use state displayed on display unit 30. Such information, however, may be generated at display unit 30. For example, control unit 20 may transmit a result of determining a use state of each container 51, to display unit 30. Controller 32 of display unit 30 may generate graphic images and texts to be displayed, based on the determination result received from control unit 20 to display them.

In the above-described embodiment, the description is made that control unit 20 is a component independent of camera 10 and display unit 30; however, control unit 20 may be unified with camera 10 or display unit 30.

Hereinbefore, the description is made of some embodiments for exemplification of the technologies in the disclosure. For this purpose, detailed descriptions and accompanying drawings are provided.

Accordingly, some components described in the detailed descriptions and accompanying drawings may include what is not essential for solving problems. Hence, the fact that such inessential components are included in the detailed descriptions and accompanying drawings does not mean that such inessential components are immediately acknowledged as essential.

The above-described embodiments are for exemplification of the technologies in the disclosure. Hence, the embodiments may undergo various kinds of change, substitution, addition, and/or omission within the scope of the claims and their equivalent technology.

### INDUSTRIAL APPLICABILITY

A container use state determining device of the present disclosure allows users and an administrator of containers to visually grasp a use state of the containers easily, and thus is useful for containers themselves, and for an aircraft and a railway vehicle equipped with containers.

What is claimed is:

1. A container use state determining device comprising:
a signal input unit that receives image data generated by photographing at least one container; and
a controller that determines a use state of the at least one container photographed from the image data and makes a display device display information indicating the use state based on a determination result.

2. The container use state determining device of claim 1, further comprising a camera that photographs the at least one container and generates the image data.

3. The container use state determining device of claim 1, further comprising the display device.

4. The container use state determining device of claim 3, wherein the display device is a projector that projects information indicating the use state to a door of the at least one container.

5. The container use state determining device of claim 3,
wherein the signal input unit receives the image data photographed by a plurality of cameras,
wherein the controller determines the use state of the at least one container based on the image data, and
wherein the display device displays information indicating the use state.

6. The container use state determining device of claim 3, wherein the display device displays information indicating a container with a given amount or more of empty space.

7. The container use state determining device of claim 6, wherein the display device displays information indicating the container with an empty space in a temporally changing manner.

8. The container use state determining device of claim 7, wherein the display device displays information indicating the container with an empty space in a cyclicly changing manner.

9. The container use state determining device of claim 7, wherein the display device displays information indicating the container with an empty space in an order according to a distance from the display device to the container with an empty space.

10. The container use state determining device of claim 3, wherein the display device displays the image data photographed by a plurality of cameras on one screen.

11. The container use state determining device of claim 1, wherein information indicating the use state includes at least one of a photographed image, a text, a mark, and a graphic image.
